(19) United States
(12) Patent Application Publication
(10) Pub. No.: US 2012/0211150 A1
(43) Pub. Date: Aug. 23, 2012

(54) Method of Orienting A Polyester Film

(75) Inventors: Larry B. McAllister, JR., Spartanburg, SC (US); Jimmy Lee Adkins, III, Simpsonville, SC (US)

(73) Assignee: Cryovac, Inc.

(21) Appl. No.: 13/030,713

(22) Filed: Feb. 18, 2011

(51) Int. Cl. B29C 55/10

(52) U.S. Cl. 156/229

(57) ABSTRACT

The present invention includes a film having at least one outer layer comprising a glycol-modified polyester and a N,N′-bis(fatty) amide. In a further aspect, embodiments of the present invention include methods for preparing oriented films having an outer layer comprising a glycol-modified polyester and a N,N′-bis(fatty) amide. In one aspect, the present invention includes a method for the concurrent transverse orientation of two films having outer layers that each comprise a blend of a glycol-modified polyester and a N,N′-bis(fatty) amide. Further aspects provide for the machine direction orientation of having an outer layer comprising a glycol-modified polyester and a N,N′-bis(fatty) amide.

### FIELD OF THE INVENTION

The present invention relates generally to methods of orienting polyester containing films, and more particularly to methods of orienting films having an outer layer comprising a modified polyester.

### BACKGROUND

Shrink sleeve labels are non-adhesive sleeves that are used to form package labels on a wide variety of articles, such as food and beverage products, pharmaceuticals, consumer products, cosmetics, personal care products and pesticides.

Shrink sleeve labels are constructed from a thermoplastic film material that is uniaxially oriented and that shrinks when heat is applied. During orientation, the film is heated above the glass transition temperature of the polymer materials and tension is applied to draw and stretch the material, followed by rapid annealing to lock in the orientation. In uniaxial orientation, tension is applied in one direction, such as in the machine or transverse direction of the film. Subsequent heating of the oriented film will cause molecular relaxation and shrinkage of the film in the direction of orientation. Once the film shrinks, it conforms tightly to the shape of the container or product, creating a sleek label and product package.

Shrink sleeve labels may include an outer film layer, often referred to as the skin layer, having surface properties that allow printing of the label with information such as graphics and product information.

Glycol-modified polyesters have been used in the skin layer due to their desirable print and optical properties. However, some glycol-modified polyesters may become tacky at orientation temperatures, which can result in undesirable welding of the film to itself or other film structures. As a result, films containing glycol-modified polyesters in the outer skin layer have been limited to certain types of orientation.

### SUMMARY

One or more embodiments of the present invention may address one or more of the aforementioned problems. In one embodiment, the present invention includes a heat shrinkable film having at least one outer layer comprising a glycol-modified polyester and a N,N′-bis(fatty) amide. In a further aspect, embodiments of the present invention include methods for preparing solid state oriented films having an outer layer comprising a modified polyester and a N,N′-bis(fatty) amide.

In one embodiment, the present invention includes a method for the concurrent solid state orientation of two films that each include an outer layer (also referred to as a skin layer) that each comprise a glycol-modified polyester. The inventors of the present invention have discovered that by blending a N,N′-bis(fatty) amide with a modified polyester in the skin layer, the tendency of the modified polyester to become tacky and adhere to itself or other film structures can be reduced or prevented. As a result, some embodiments of the present invention may permit additional solid state orientation methods for films having a skin layer comprising a modified polyester.

In one embodiment, the present invention is directed to a method of concurrently orienting two sheets of film that each include a skin layer comprising a modified polyester. For example, in one alternative embodiment the invention is directed to a method comprising the steps of positioning a first film comprising a skin layer comprising a modified polyester and a N,N′-bis(fatty) amide and a second film comprising a modified polyester and a N,N′-bis(fatty) amide so that the skin layer of the first film contacts the skin layer of the second film. The first and second films are heated to an orientation temperature, and then stretched in at least one direction while at the orientation temperature, and while the skin layers of the first and second films are contacting each other. In one embodiment, the first and second films undergo transverse direction orientation (TDO), machine direction orientation (MDO), or biaxial orientation.

In addition, embodiments of the present invention may also provide for machine direction orientation (MDO) of films having a modified polyester in the skin layer. As in TDO, films having a skin layer comprising a modified polyester have a tendency to adhere to other film structures and also to the stretching apparatus, such as the rollers. As a result, the use of MDO in films having an outer layer comprised of a modified polyester has been limited due to the film adhering to rollers during the orientation process. The inventors have discovered that by blending a N,N′-bis(fatty) amide with a modified polyester in the skin layer, this tendency of the modified polyester to adhere to the rollers and other processing equipment can be reduced or prevented.

Suitable N,N′-bis(fatty) amide for use in embodiments of the present invention may include N,N′-bis(fatty) amides having from about 18 to about 48 carbon atoms. For example, the N,N′-bis(fatty) amide may have from about 18 to about 36 carbon atoms, and in particular, from about 18 to about 26 carbon atoms. Useful N,N′-bis(fatty) amide may include N,N′-ethylene bis(stearamide), N,N′-methylene bis(stearamide), N,N′-propylene bis(stearamide), N,N′-ethylenebis(oleamide), N,N′-methylene bis(oleamide), or N,N′-propylene bis(oleamide), and combinations thereof.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a cross-section view of a multilayer film that is in accordance with at least one embodiment of the present invention;

FIG. 2 illustrates two film layers that are in accordance with at least one embodiment of present invention being concurrently oriented in the transverse direction;

FIG. 3 is a top view schematic showing an apparatus for transverse orientation of films in accordance with embodiments of the present invention;

FIG. 4 is a schematic view of a film in accordance with embodiments of the present invention being oriented in the machine direction;

FIG. 5 is a representative perspective view of a shrink sleeve comprising an embodiment of the film of the present invention surrounding a container; and

FIG. 6 is a representative perspective view of the shrink sleeve of FIG. 5 shrunk about the container to provide a shrink labeled container.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements.

Embodiments of the present invention are directed to methods of solid state orienting a film having an outer layer (also referred to herein as a skin layer) comprising a modified polyester and a N,N′-bis(fatty) amide. The inventors of the present invention have surprisingly discovered that the inclusion of one or more N,N′-bis(fatty) amides in an outer layer of a film comprising a modified polyester may help reduce the tendency of the modified polyester from becoming tacky during solid state orientation. As a result, some embodiments of the present invention may permit additional solid state orientation methods to be used in the orientation of films having one or more outer layers comprising modified polyesters.

In one embodiment, the present invention is directed to a method of concurrently solid state orienting two films comprising the steps of positioning a first film comprising a skin layer comprising glycol-modified polyester and a N,N′-bis(fatty) amide and a second film comprising a glycol-modified polyester and a N,N′-bis(fatty) amide so that the skin layer of the first film contacts the skin layer of the second film; heating the first and second films to an orientation temperature; and stretching the first and second films in at least one direction while at the orientation temperature, and while the skin layers of the first and second films are contacting each other. Advantageously, the inventors have discovered that the inclusion of a N,N′-bis(fatty) amide in the skin layer helps prevent or reduce the tendency of the skin layer to weld to each other during concurrent orientation. The term “weld” or “welding” as used in connection with welding of two films to each other during concurrent orientation, generally refers to the undesirable tendency of outer layers of two films to become adhered to each other, such as through the formation of a heat seal, when in contact with each other and heated to an orientation temperature. It should be recognize that in some embodiments, some slight adherence of the films may be acceptable provided the films can be separated with minimal force, and in particular, without tearing, delaminating, or otherwise damaging the films.

In a further embodiment, the present invention is directed to a method of solid state orienting a film in the machine direction comprising the steps of providing a film having an outer layer comprising modified polyester and N,N′-bis(fatty) amide, heating the film to an orientation temperature, passing the film over at least one roller to orient the heated film while at the orientation temperature of the film, and stretching the heated film in the machine direction while at the orientation temperature.

The term “solid-state orientation” describes an orientation process carried out at a temperature higher than the highest glass transition temperature (Tg) of the polymers making up the film structure and lower than the highest melting point (Tm) of at least one polymer—that is, at a temperature where the polymers, or at least some of the polymers, are not in the molten state. “Solid-state orientation” is contrasted to “melt-state orientation,” which is a process, such as the hot blown tubular film process, where stretching takes place upon emergence of the molten resins from the die. As used herein, the term “orientation” and “oriented” mean “solid-state orientation” and “solid-state oriented,” respectively, so that a film that is “non-oriented” means that the film has not undergone solid-state orientation.

A film structure may be “solid-state oriented” (i.e., oriented), for example, by quenching a relatively thick tube, which is then reheated to the so-called orientation temperature (i.e., above the Tg and below the Tm as discussed above), and then biaxially stretched at this temperature by a tubular solid-state orientation process using a trapped bubble. In certain embodiments of the present invention, solid state orientation may also be carried out, for example, by use of a tentering frame or by use of a series of heated and speed controlled rollers, as is known in the art.

The “orientation temperature” generally refers to the temperature of the film while being stretched. In the case of a glycol-modified polyester, the orientation temperature is above the glass transition temperature, for example, about 5 to about 30° C. above the glass transition temperature, and below the melting point of the polymer. Thus, for glycol-modified polyester the orientation temperature is generally in a range from about 80 to about 100° C., and in particular from about 88 to about 94° C., and more particularly, from about 90 to about 92° C.

In one embodiment, the present invention provides a method of solid state orientation of a film in which the film is oriented at an orientation temperature that is at most one of 40° C., 30° C., 25° C., 20° C., 15° C., 10° C., and 5° C. above the glass transition temperature of the modified polyester. In one particular embodiment, the film is oriented at an orientation temperature that is from 6 to 30° C. above the glass transition temperature of the modified polyester.

Unless specified otherwise, the Tg is measured at a relative humidity of 0%. All references to the glass transition temperature of a polymer, a polymer mixture, a resin, a film, or a layer in this Application refer to the characteristic temperature at which amorphous polymers, or the amorphous part of semi-crystalline polymers, of the sample changes from a hard, glassy, or brittle state to a soft, flexible, rubbery state, as measured by dynamic mechanical analysis (“DMA”) according to ASTM D4065 and ASTM D5026, using a dynamic displacement frequency of 22 radians/second, an amplitude of displacement of 0.1% strain, a thermal gradient of 3° C./minute, and a nitrogen atmosphere, where the temperature is ramped from −150° C. up to the point of loss of transducer sensitivity (i.e., when the film falls apart). The Tg is the tan delta beta transition peak temperature averaged for two samples.

Embodiments of the present invention are directed to monoaxially and biaxially orienting a film including orienting a film in at least one of the transverse and machine directions. In one embodiment, the film may be solid-state oriented in any direction by less than any of the following ratios: 1.5:1, 2:1, 2.5:1, 2.8:1; 2.9:1, 3:1, 3.5:1 , 4:1, 5:1, 6:1, 7:1, 8:1, 9:1, and 10:1.

Films in accordance with embodiments of the present invention may be monolayered or multilayered. For example, the film may comprise at least, and/or at most, any of the following numbers of layers: 1, 2, 3, 4, 5, 6, 7, 8, 9, 10, 11, 13, and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application.

Below are some examples of combinations in which the alphabetical symbols designate the film layers. Where the multilayer film representation below includes the same letter more than once, each occurrence of the letter may represent the same composition or a different composition within the class that performs a similar function.
A/B, A/B/A, A/C/B, A/C/B/A, A/C/B/C/A, A/B/D, A/D/B, A/CID/B, A/D/C/B, A/C/B/D, A/C/D/C/B, A/D/B/C/A, A/C/B/D/A, A/C/D/B, A/D/B/D/A, A/C/D/B/C/A, A/C/D/B/D/C/A, A/B/B/A, A/C/B/B/A, A/C/B/B/C/A, A/B/D/B/A, A/C/B/D/B/C/A, A/B/B
“A” represents a skin layer, as discussed below.
“B” represents a base layer, as discussed below.
“C” represents an intermediate layer (e.g., a tie layer), as discussed below.
“D” represents a bulk layer, as discussed below.

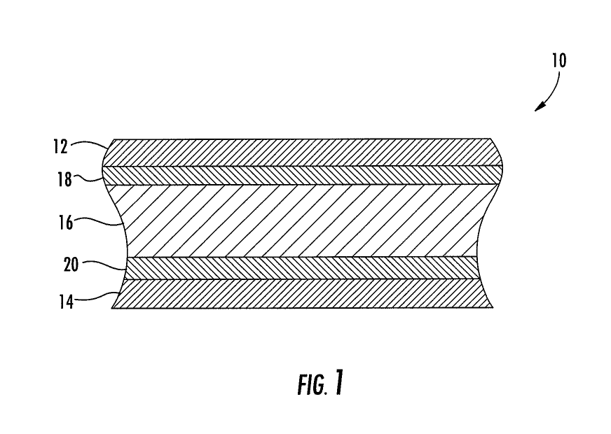

With reference to FIG. 1, a film in accordance with at least one embodiment of the present invention is illustrated and designated by reference number 10. Film 10 includes two outer layers 12, 14 defining an outer surface of the film, a base layer 16 defining an interior layer of the film, and intermediate tie layers 18, 20 joining the base layer 16 to the two outer layers 12, 14. At least one of outer layers 12, 14 defines a skin layer of the film that comprises a modified polyester and a N,N′-bis(fatty) amide. In some embodiments, outer layers 12, 14 are identical to each other (e.g., both outer layers comprise a modified polyester and a N,N′-bis(fatty) amide).

The film may comprise at least one skin layer forming an outer surface of the film. A skin layer is an “outer layer” of the film, that is, a layer that has only one side directly adhered to another layer of the film. For multilayered films, there inherently exists two outer layers of the film. An “outside layer” is an outer layer of the film that is, or is intended to be, facing outwardly from a label or package comprising the film. An “inside layer” of a film is an outer layer of the film that is, or is intended to be, facing inwardly from a label comprising the film (i.e., toward the labeled item) or from a package comprising the film (i.e., toward the package interior space).

In addition to a first skin layer, the film may comprise a second skin layer as an outer layer of the film. The composition, thickness, and other characteristics of the first and second skin layers may be any of those described below with respect to the skin layer. Any of the composition, thickness, and other characteristics of the second skin layer may be substantially the same as any of those of the first skin layer, or may differ from any of those of the first skin layer.

The first and/or second skin layers may each have a thickness of at least about, and/or at most about, any of the following: 0.05, 0.1, 0.15, 0.2, 0.25, 0.5, 1, 2, 3, 4, and 5 mils. The thickness of a skin layer as a percentage of the total thickness of the film may be at least about, and/or at most about, any of the following: 1, 3, 5, 7, 10, 15, 20, 25, 30, 35, 40, 45, and 50 percent.

The first and/or second skin layers may each comprise a modified polyester (e.g., glycol-modified polyester and a N,N′-bis(fatty) amide). Exemplary modified polyester includes glycol-modified polyesters and acid-modified polyesters. Modified polyesters may be made by polymerization with more than one type of comonomer in order to disrupt the crystallinity and thus render the resulting polyester more amorphous.

Polyester includes polymers made by: 1) condensation of polyfunctional carboxylic acids with polyfunctional alcohols, 2) polycondensation of hydroxycarboxylic acid, and 3) polymerization of cyclic esters (e.g., lactone).

Exemplary polyfunctional carboxylic acids (which includes their derivatives such as anhydrides or simple esters like methyl esters) include aromatic dicarboxylic acids and derivatives (e.g., terephthalic acid, isophthalic acid, dimethyl terephthalate, dimethyl isophthalate, naphthalene-2,6-dicarboxylic acid;) and aliphatic dicarboxylic acids and derivatives (e.g., adipic acid, azelaic acid, sebacic acid, oxalic acid, succinic acid, glutaric acid, dodecanoic diacid, 1,4-cyclohexane dicarboxylic acid, dimethyl-1,4-cyclohexane dicarboxylate ester, dimethyl adipate). Representative dicarboxylic acids may be represented by the general formula: HOOC—Z—COOH where Z is representative of a divalent aliphatic radical containing at least 2 carbon atoms. Representative examples include adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid (“I”) and terephthalic acid (“T”). As is known to those of skill in the art, polyesters may be produced using anhydrides and esters of polyfunctional carboxylic acids.

Exemplary polyfunctional alcohols include dihydric alcohols (and bisphenols) such as ethylene glycol, 1,2-propanediol, 1,3-propanediol, 1,3 butanediol, 1,4-butanediol, 1,4-cyclohexanedimethanol, 2,2-dimethyl-1,3-propanediol, 1,6-hexanediol, poly(tetrahydroxy-1,1′-biphenyl, 1,4-hydroquinone, bisphenol A, and cyclohexane dimethanol (“CHDM”).

Exemplary hydroxycarboxylic acids and lactones include 4-hydroxybenzoic acid, 6-hydroxy-2-naphthoic acid, pivalolactone, and caprolactone.

Exemplary polyesters may be derived from lactone polymerization; these include, for example, polycaprolactone and polylactic acid.

A glycol-modified polyester is a polyester derived by the condensation of at least one polyfunctional carboxylic acid with at least two types of polyfunctional alcohols. For example, glycol-modified poly(ethylene terephthalate) or “PETG” may be made by condensing terephthalic acid with ethylene glycol and cyclohexane dimethanol (“CHDM”). A useful PETG is available from Eastman Corporation under the EASTAR® 6763 trade name, and is believed to have about 34 mole % CHDM monomer content, about 16 mole % ethylene glycol monomer content, and about 50 mole % terephthalic acid monomer content. Another useful glycol-modified polyester may be made similar to PETG, but substituting dimethyl terephthalate for the terephthalic acid component. Further glycol-modified polyesters that may be used in embodiments of the present invention are available from Eastman Chemical Company under the tradename EMBRACE®. Yet another exemplary glycol-modified polyester is available under the ECDEL® 9965 trade name from Eastman Corporation, and is believed to have a density of 1.13 g/cc and a melting point of 195° C. and to be derived from dimethyl 1,4 cyclohexane-dicarboxylate, 1,4 cyclohexane-dimethanol, and poly(tetramethylene ether glycol).

The modified polyester may be selected from random polymerized modified polyester or block polymerized polyester.

The modified polyester may be derived from one or more of any of the constituents discussed above. If the modified polyester includes a mer unit derived from terephthalic acid, then such mer content (mole %) of the diacid of the polyester may be at least about any the following: 70, 75, 80, 85, 90, and 95%.

The modified polyester may be thermoplastic. The modified polyester may be substantially amorphous, or may be partially crystalline (semi-crystalline). The modified polyester and/or the skin layer may have a crystallinity of at least about, and/or at most about, any of the following weight percentages: 5, 10, 15, 20, 25, 30, 35, 40, and 50%.

The crystallinity may be determined indirectly by the thermal analysis method, which uses heat-of-fusion measurements made by differential scanning calorimetry (“DSC”). All references to crystallinity percentages of a polymer, a polymer mixture, a resin, a film, or a layer in this Application are by the DSC thermal analysis method, unless otherwise noted. The DSC thermal analysis method is believed to be the most widely used method for estimating polymer crystallinity, and thus appropriate procedures are known to those of skill in the art. See, for example, “Crystallinity Determination,” Encyclopedia of Polymer Science and Engineering, Volume 4, pages 482-520 (John Wiley & Sons, 1986), of which pages 482-520 are incorporated herein by reference.

Under the DSC thermal analysis method, the weight fraction degree of crystallinity (i.e., the “crystallinity” or “Wc”) is defined as ΔHf/ΔH ° f,c, where “ΔHf” is the measured heat of fusion for the sample (i.e., the area under the heat-flow versus temperature curve for the sample) and “Δ ° f,c” is the theoretical heat of fusion of a 100% crystalline sample. The ΔH.degree. f,c values for numerous polymers have been obtained by extrapolation methods; see for example, Table 1, page 487 of the “Crystallinity Determination” reference cited above. The ΔH ° f,c for polymers are known to, or obtainable by, those of skill in the art. The ΔH ° f,c for a sample polymer material may be based on a known ΔH ° f,c for the same or similar class of polymer material, as is known to those of skill in the art. For example, the ΔH ° f,c for polyethylene may be used in calculating the crystallinity of an EVA material, since it is believed that it is the polyethylene backbone of EVA rather than the vinyl acetate pendant portions of EVA, that forms crystals. Also by way of example, for a sample containing a blend of polymer materials, the ΔH ° f,c for the blend may be estimated using a weighted average of the appropriate ΔH ° f,c for each of the polymer materials of separate classes in the blend.

The DSC measurements may be made using a thermal gradient for the DSC of 10° C./minute. The sample size for the DSC may be from 5 to 20 mg.

Suitable N,N′-bis(fatty) amide for use in embodiments of the present invention may include N,N′-bis(fatty) amides having from about 18 to about 48 carbon atoms. For example, the N,N′-bis(fatty) amide may have from about 18 to about 36 carbon atoms, and in particular, from about 18 to about 26 carbon atoms. In one embodiment, suitable N,N′-bis(fatty) amides for use in the present invention may have the following formula:

R₁—(CONH)—(CH₂)n-(CONH)—R₂ where

CONH is an amide group;

n is a number from 1 to 3 (e.g., methyl to propyl); and

R₁ and R₂ are independently alkyl chains have from 12 to 30 carbon atoms.

Useful N,N′-bis(fatty) amide may include N,N′-ethylene bis(stearamide), N,N′-methylene bis(stearamide), N,N′-propylene bis(stearamide), N,N′-ethylene bis(oleamide), N,N′-methylene bis(oleamide), or N,N′-propylene bis(oleamide), and combinations thereof. A suitable N,N′-bis(fatty) amide is ethylene bis-stearamide available from Chemtura under the tradename KEMAMIDE W40. In one embodiment, the N,N′-bis(fatty) amide comprises one or more of N,N′-ethylene bis(oleamide) and N,N′-ethylene bis(stearamide.

The N,N′-bis(fatty) amide may be present in an amount from about 2,200 to about 6,000 parts per million (ppm) based on the total constituents (total ppm) of the skin layer, and in particular from about 3,000 to about 4,400 ppm, based on the total ppm of the skin layer. In one embodiment, the N,N′-bis(fatty) amide may be present in the skin layer in an amount from about 3,600 to about 5,200 ppm based on the total ppm of the skin layer. In other embodiments, the N,N′-bis(fatty) amide may be present in the skin layer in an amount that is at least 3600 ppm, based on the total ppm of the skin layer.

In addition to the modified polyester and N,N′-bis(fatty) amide, the skin layer may also include additional agents such as antiblock agents, antiskid agents, viscosity modifiers, and the like.

One or more layers of the film may include one or more additives useful in thermoplastic films, such as, antiblocking agents, slip agents, antifog agents, colorants, pigments, dyes, flavorants, antimicrobial agents, meat preservatives, antioxidants, fillers, radiation stabilizers, and antistatic agents.

Modulus of the Film

Films in accordance with embodiments of the present invention, may desirably exhibit a Young's modulus sufficient to withstand the expected handling and use conditions. Young's modulus may be measured in accordance with one or more of the following ASTM procedures: D882; D5026-95a; D4065-89, each of which is incorporated herein in its entirety by reference. The film may have a Young's modulus of at least about, and/or at most about, any of the following: 60,000; 100,000; 130,000; 150,000; 200,000; 250,000; 300,000; and 350,000 pounds/square inch, measured at a temperature of 73° F. The film may have any of the forgoing ranges of Young's modulus in at least one direction (e.g., in the machine direction or in the transverse direction) or in both directions (i.e., the machine (i.e., longitudinal) and the transverse directions).

Appearance Characteristics of the Film

The film may have low haze characteristics. Haze is a measurement of the transmitted light scattered more than 2.5° from the axis of the incident light. Unless otherwise noted, haze is measured against the outside layer of the film. The “outside layer” is the outer layer of the film that is or is intended to be adjacent the space outside of a package comprising the film. (The “inside layer” of a film is the outer layer of the film that is or is intended to be adjacent the space inside of a package comprising the film.) Haze is measured according to the method of ASTM D 1003, which is incorporated herein in its entirety by reference. All references to a “haze” value for a film in this application are by this standard. The haze of the film—measured at a time selected from before the forming step or after the forming step—may be at most about any of the following values: 30%, 25%, 20%, 15%, 10%, 8%, 5%, 3, and 2%.

The film may have a gloss (i.e., specular gloss) as measured against the outside layer—measured at a time selected from before the forming step or after the forming step—of at least about any of the following values: 40%, 50%, 60%, 63%, 65%, 70%, 75%, 80%, 85%, 90%, and 95%. These percentages represent the ratio of light reflected from the sample to the original amount of light striking the sample at the designated angle. All references to “gloss” values in this application are in accordance with ASTM D 2457 (45° angle), which is incorporated herein in its entirety by reference.

The film may be transparent (at least in the non-printed regions) so that a packaged article may be visible through the film. “Transparent” means that the film transmits incident light with negligible scattering and little absorption, enabling objects (e.g., the packaged article or print) to be seen clearly through the film under typical viewing conditions (i.e., the expected use conditions of the material). The regular transmittance (i.e., clarity) of the film—measured at a time selected from before the forming step or after the forming step—may be at least about any of the following values: 65%, 70%, 75%, 80%, 85%, and 90%, measured in accordance with ASTM D1746. All references to “regular transmittance” values in this application are by this standard.

The total luminous transmittance (i.e., total transmittance) of the film—measured at a time selected from before the forming step or after the forming step—may be at least about any of the following values: 65%, 70%, 75%, 80%, 85%, and 90%, measured in accordance with ASTM D1003. All references to “total luminous transmittance” values in this application are by this standard.

The measurement of optical properties of plastic films, including the measurement of total transmission, haze, clarity, and gloss, is discussed in detail in Pike, LeRoy, “Optical Properties of Packaging Materials,” Journal of Plastic Film & Sheeting, vol. 9, no. 3, pp. 173-80 (July 1993), of which pages 173-80 is incorporated herein by reference.

Manufacture of the Film

Films in accordance with the present invention may be manufactured by thermoplastic film-forming processes known in the art. The film may be prepared by extrusion or coextrusion utilizing, for example, a tubular trapped bubble film process, a flat or tube cast film process, or a slit die flat cast film process. The film may also be prepared by applying one or more layers by extrusion coating, adhesive lamination, extrusion lamination, solvent-borne coating, or by latex coating (e.g., spread out and dried on a substrate). A combination of these processes may also be employed. These processes are known to those of skill in the art.

As briefly noted above, some embodiments of the film having a skin layer comprising a modified polyester and a N,N′-bis(fatty) amide may be oriented using orientation processes that were previously unsuitable for films having a skin layer comprising a modified polyester. For example, some embodiments of the present invention provide a method of orienting a film having a skin layer comprising a modified polyester in which two such films are transverse oriented concurrently. In this embodiment, two films can be positioned in a face-to-face relation so that the skin layer of one of the films contacts the skin layer of the other film during the orientation process. The two thus positioned films can then be oriented in the transverse direction using a tenter frame or similar device as is known to one of skill in the art. Previous films having a having a skin layer comprising a modified polyester would be unsuitable for such concurrent orientation due to welding of the films to each other during orientation. As discussed above, the inclusion of a N,N′-bis(fatty) amide in the skin layer comprising a modified polyester helps to prevent welding of the film to itself or other films.

In one embodiment, the present invention encompasses the concurrent orientation of two separate films that are positioned in face-to-face contact with each other. Alternatively, the two films can be formed from a single sheet of film that is folded along one or two opposing longitudinally extending side edges. For example, the two films can have a tubular configuration (.e.g., a collapsed bubble) having continuous extending sidewalls that have been folded along opposing side edges to define two films that each have skin layers that are disposed in face-to-face contact with each other.

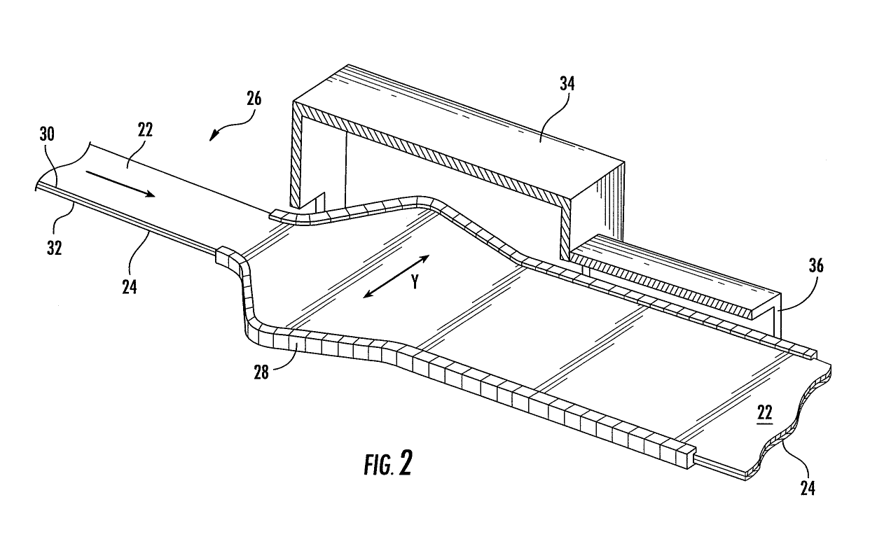

FIG. 2 illustrates two films being concurrently transversely oriented using a tenter frame system. As shown, first and second elongated bodies of film 22, 24 are provided extending along a first, X axis which is parallel to the longitudinal direction of film movement. The first film 22 is shown overlying and in contact with the second film 24 in the longitudinal direction X of the film. In particular, the first film 22 and the second film 24 each have a skin layer comprising a modified polyester and a N,N′-bis(fatty) amide, and are positioned so that the skin layers of each film are in contact with each other during orientation.

In the embodiment depicted in FIG. 2, the films 22, 24 are preheated in a preheating zone 26 prior to orientation of the film in the transverse direction (e.g., along the second transverse axis Y). In one embodiment, the film is heated to a temperature above the glass transition temperature of the modified polyester of the skin layer, for example, above about 70° C. In one embodiment, the films are heated from about 80° C. to about 100° C., and in particular from about 85° C. to about 95° C. Other methods of heating the first and second films to an orientation temperature may include infrared (IR) heaters and hot water baths.

Following the pretreatment, the films enter a stretching stage in which the films pass through an orientation oven 34. In one embodiment, the orientation oven may include multiple nozzles that direct heated air against the films. Tensile force is applied to the films along the second, transverse axis Y to orient the films in the transverse direction. As shown, a tenter frame 28 may be utilized which includes an endless chain of grippers or clamps configured to grip the edges 30, 32 of the first and second films 22, 24. Such tenter frames are commonly utilized in the art to orient films in the transverse direction. Tenter frame 28 grips the edges of the longitudinal films, applying a tensile force to the film and overstretching the film, increasing the width of the film and orientating the film in the transverse direction. In some embodiments, the orientation oven is maintained at a temperature that may be from about 80° C. to 100° C., and in particular from about 85° C. to 95° C.

Following orientation, the films may be cooled to lock in the desired orientation and shrink properties. In some embodiments, a cooling chamber 36 may be provided to cool the films to room temperature. The temperature of the first and second films may be lowered to room temperature by a variety of mechanisms other than cooling chamber 36 and remain within the scope of the present invention. Generally, it may be desirable to gradually cool the film from the orientation temperature to room temperature.

After the first and second films 22, 24 exit the cooling chamber 36, the tenter frame 28 releases the transverse tension in the films. The thus oriented films can then be wound onto a roll (not shown). In one embodiment, a roller takeup is utilized for winding the films onto cores for storage.

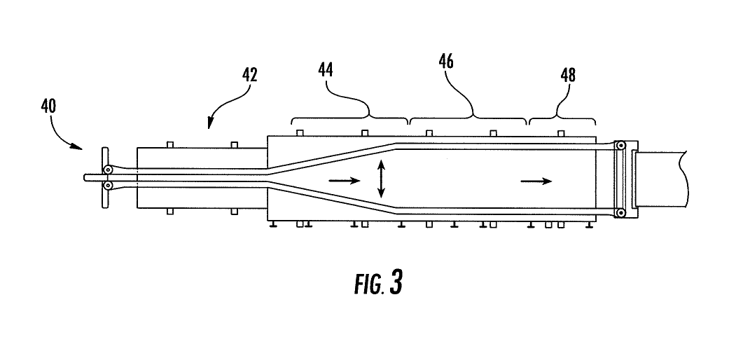

FIG. 3 is a top view of a tenter frame system that may be used to orient two films concurrently. As shown, the tenter frame system 40 includes a preheating zone 42, a drawing zone 44, an annealing zone 46, and a cooling zone 48. As discussed above, the preheating zone may include multiple air nozzles that heat the films to an orientation temperature. In the annealing zone, the oriented films may be rapidly cooled to lock in the orientation.

In a further aspect, embodiments of the present invention provide a method for orienting the film in the machine direction. As discussed previously, the use of machine direction orientation (MDO) of films having an outer layer (e.g., skin layer) comprising a modified polyester has generally been limited because of the tendency of the modified polyester layer to adhere to the rollers or other processing equipment at orientation temperatures. As discussed above, the inventors have discovered that the inclusion of a N,N′-bis(fatty) amide in an outer layer comprising a modified polyester helps to prevent the film from adhering to the rollers or other processing equipment during machine direction orientation. As a result, films in accordance with some embodiments of the present invention can also be used to prepare machine direction oriented films.

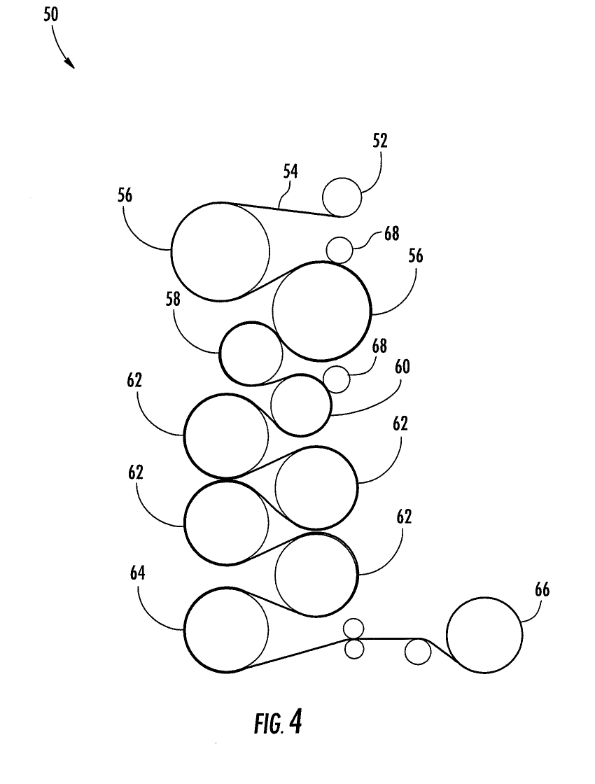

FIG. 4 illustrates a system 50 that may be used to orient a film having one or more outer layers that comprise a blend of a modified polyester and a N,N′-bis(fatty) amide. As shown, a film 54 can be provided via supply roll 52. The film 52 is heated to an orientation temperature (e.g., by passing the film over at least one heated roller). In the illustrated embodiment, the film 52 is heated by passing the film over a series of heating rollers 56 where the film is heated to an orientation temperature. Once heated, the film is then passed over a slow draw roller 58 and a fast draw roller 60 where the film is stretched and oriented in the machine direction. As is known to one of skill in the art, the stretching rollers may successively each be drawn at a higher rate of speed so as to draw and stretch the film in the machine direction. Following stretching, the films are passed over a series of annealing and/or cooling rollers 62 that cool the film and lock in the orientation. In some embodiments, the film may also be passed over a chill roller 64. The thus oriented film may then be wound onto a supply roll 66 for immediate or later use. The system 50 may also include a nip roller 68 associated with one or more of the rollers to help maintain contact of the film with the surface of the roller. It should be recognized that the number of rollers depicted in FIG. 4 is for explanation only, and that each stage may include less or more rollers as needed. It should also be noted that the film can be heated to an orientation temperature using other methods, such as heated air, infrared heating, and the like.

As noted above, the inclusion of the N,N′-bis(fatty) amide with the modified polyester in the outer layer helps prevent or reduce the tendency of the outer layer to adhere or stick to the surface of the rollers. In one embodiment, one or more of the rollers used to orient the film in the machine direction may be steel rollers. In some embodiments, one or more of the rollers may have a matte finish.

Films oriented in accordance with embodiments of the present invention may have a free shrink at 100° C. in one direction (e.g., the machine direction or the transverse direction) and/or in both the machine and transverse directions of at least about, and/or at most about, any of the following: 5%, 7%, 9%, 10%, 12%, 15%, 25%, 30%, 40%, 45%, 50%, 55%, 60%, 70%, 75%, and 80%. The film may have any of the forgoing shrink amounts in the machine and/or transverse directions at any of the following temperatures: 90, 80, 70, 60, 50, and 40° C. For example, the film may have a free shrink at 80° C. in the transverse direction of at least about 60% and a free shrink at 60° C. in the machine direction of at most about 10%. Also, the film may have any combination of the forgoing shrink values at differing temperatures; for example, the film may have a free shrink at 90° C. in at least one direction of at least about 75% and a free shrink at 70° C. in any direction of at most about 5%.

The film may be annealed, for example, to decrease the shrink attribute at a selected temperature (e.g., 70° C.). The film may be annealed or heat-set to slightly or substantially reduce the free shrink of an oriented film, for example to raise the shrink initiation temperature. The film may have less than about any of 3%, 2%, and 1% free shrink in any direction at any of the following temperatures: 70, 65, 60, 55, 50, 45, and 40° C.

The free shrink of the film is determined by measuring the percent dimensional change in a 10 cm×10 cm film specimen when subjected to selected heat (i.e., at a specified temperature exposure) according to ASTM D 2732, which is incorporated herein in its entirety by reference. All references to free shrink in this application are measured according to this standard.

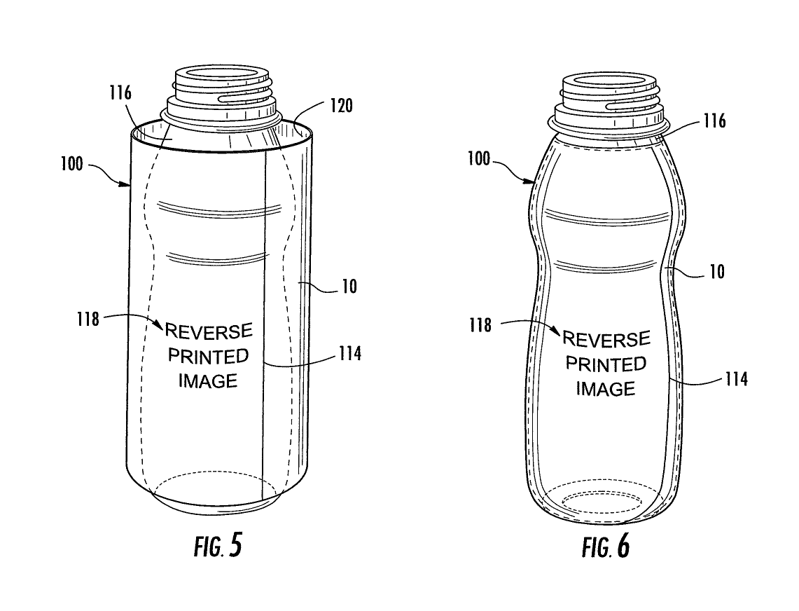

Embodiments of the present invention may also be directed to shrink sleeve labels having a skin layer comprising a modified polyester and a N,N′-bis(fatty) amide. In this regard, FIG. 5 illustrates a shrink sleeve label 100 (also known as a shrink sleeve or a shrink band) that may comprise a film (e.g., film 10 of FIG. 1) having a skin layer comprising a modified polyester and a N,N′-bis(fatty) amide. The shrink sleeve label 100 may be a seamed shrink sleeve label (illustrated in FIG. 1), a seamless shrink sleeve, or a roll-fed shrink sleeve (i.e., formed by roll-fed shrink film for wraparound labeling). Suitable film structures for use in shrink sleeve applications are described in greater detail in U.S. Patent Publication Nos. 2007/0098933 and 2008/0197540, the contents of which are incorporated by reference in their entirety.

A seamed shrink sleeve label that comprises the film may be manufactured from a flat configuration of the film, which is seamed into a tube by attaching the film to itself to form a tube having a seam 114 using, for example, an adhesive seam. If the shrink sleeve label 100 is to be printed, then the formation of the film into a tube may occur after images have been printed onto the film. The printed image 118 may be applied as a reverse printed image to the inside surface 120. The tube may then be wound onto a core. The roll of tubing may then be unwound from the core and cut to individual lengths to form the individual seamed shrink sleeve labels. The shrink sleeve label may then be placed to surround the item (e.g., container 116) to which the shrink sleeve label is to be applied. Heat may then be applied (e.g., by placing the shrink-sleeved item into a heat tunnel using, for example, steam or hot air) so that the heat shrink characteristic of the shrink sleeve is activated and the shrink sleeve shrinks to conform to the shape of the item that the shrink sleeve surrounds, as illustrated in FIG. 6.

A seamless shrink sleeve that comprises the film may be manufactured by extruding the film in a tube configuration having a desired tube configuration. The resulting tube may be printed and cut to desired lengths to form individual shrink sleeves.

A roll-fed shrink sleeve comprising the film may be manufactured by: 1) applying a pick-up adhesive to the leading edge of the film that has been cut into the desired dimensions, 2) adhering the leading edge to a container, 3) moving the container and the film relative each other so that the film surrounds the container, 4) applying an adhesive to the trailing edge of the film, 5) adhering the trailing edge of the film to the container or to the leading edge area of the film, and 6) exposing the shrink sleeve/container to heat to activate the shrink characteristic of the film.

A shrink sleeve comprising the film may be used, for example: 1) as a label applied to an item, 2) as a tamper-evident seal or packaging material (e.g., a tamper-evident neck band), and/or 3) to unitize two or more items (e.g., multi-packing) The shrink sleeve may be a full-body sleeve for enclosing a container. The shrink sleeve may be used to enclose a shaped and/or contoured container (e.g., an asymmetrically-shaped container).

The invention may be further understood by reference to the following examples, which are provided for the purpose of representation, and are not to be construed as limiting the scope of the invention in any way.

### EXAMPLES

Various five-layer films were made by cast extruding films having an A/C/B/C/A film layer configuration. The films produced in the Examples were cast extruded. The materials used in the films are identified below. All percentages are weight percents unless indicated otherwise. All physical property and compositional values are approximate unless indicated otherwise.

“EVA” maleic anhydride-grafted ethylene/vinyl acetate copolymer available from Dupont Corporation under the BYNEL® 3861 trademark.

“PET” is a poly(ethylene)terephthalate) copolymer available from Eastman Chemical Company under the tradename PET 9921.

“PETG-1” is a glycol-modified poly(ethylene)terephthalate) having a glass transition of 75° C., available from Eastman Chemical Company under the EMBRACE™ trademark.

“PETG-2” is a glycol-modified poly(ethylene)terephthalate) having a glass transition of 71° C., available from Eastman Chemical Company under the tradename EMBRACE® LV.

“PS1” is a polystyrene available from INEOS NOVA LLC under the product name PS 3100.

“PS2” is a polystyrene available from INEOS NOVA LLC under the product name Crystal PS 1300.

“SBC” is a styrene butadiene copolymer available from BASF under the trademark STYROLUX® HS 70.

“EBA” is an ethylene bis-stearamide available from Chemtura under the tradename KEMAMAMIDE® W40.

“CPE-1” is a copolyester masterbatch having a glass transition of 80° C., available from Eastman Chemical Company under the trademark EASTAR™ 6763C0235.

“AB” is an antiblock comprised of ceramic microspheres available from 3M under the trademark ZEEOSPHERES™ W410.

“EMA-1” is an ethylene-methyl acrylate copolymer available from Westlake chemical Corporation available under the tradename EMAC® SP2260 believed to have a ethylene-methyl content of 24% wt. %.

“EMA-2” is an ethylene-methyl acrylate copolymer provided by Eastman Chemical Company under product name SP2260, now available from Westlake chemical Corporation available under the tradename EMAC® SP2260.

“SEPS” is a Styrene Ethylene Propylene Styrene Block Copolymer available from Kraton Polymers under the tradename KRATON® G1643

“PEC” is a propylene-ethylene copolymer available from Dow Chemical Company under the tradename VERSIFY™ 2200.

“EA” is an erucamide wax available from PMC Biogenix under the trademark KEMAMIDE® E Ultra powder.

“POC” is a polyolefin elastomer available from Dow Chemical Company under the trademark ENGAGE® 8157.

“COC” is an alpha-olefin/cyclic-olefin copolymer with a glass transition of 30° C. available from by Ticona under the product name TOPAS® 9506 X1.

“PET-EA” is PETG carrier resin comprising 20 wt. % erucamide wax available from Eastman Chemical under the product name 6763C0030.

“MB-1” is a masterbatch containing 93.5 weight % PETG, 3 weight % EBA, and 3.5 weight % AB.

“MB-2” is a masterbatch containing 93.5 weight % PETG, 2.5 weight % EBA, 3.5 weight % AB, and 0.5 weight % EA.

“MB-3” is a masterbatch containing 82.5 weight % PETG, 3.5 weight % EBA, 4 weight % AB, and 10 weight % PET.

Multilayer films having a 5-layer structure were prepared, with each layer being listed in the same order in which it appeared in the film.

Control Film 1

In Control Film 1 the “A” skin layers were a blend of PETG and CPE-2, and the “B” base layer (“core layer”) was a blend of 80 wt. % SBC and 20 wt. % CPE-2. The “C” tie layers comprised a blend of 90 wt. % EVA and 10 wt. % COC. The film was extruded using a Randcastle cast extruder and had a thickness of 1.8 mils.

| Layer | | | | Thickness | |
|---|---|---|---|---|---|
| No. | Function/Position | Layer Composition | Weight % | (mils) | Thickness (%) |
| Layer 1 | Interior Skin layer: | 96.5% PETG-1, 3.5% CPE | 16.6 | 0.25 | 13.9 |
| Layer 2 | Tie Layer: | 90% EVA, 10% COC | 9.1 | 0.185 | 10.3 |
| Layer 3 | Core Layer: | 80% SBC, 20% PS 1 | 48.6 | 0.930 | 51.7 |
| Layer 4 | Tie Layer | 90% EVA, 10% COC | 9.1 | 0.185 | 10.3 |
| Layer 5 | Outer Skin Layer: | 96.5% PETG-1, 3.5% CPE | 16.6 | 0.25 | 13.9 |

Comparative Film 1

Comparative Film 1 was prepared in a similar manner to Control Film 1 with the exception that the skin layers included a euracamide wax component.

| Layer | | | | Thickness | |
|---|---|---|---|---|---|
| No. | Function/Position | Layer Composition | Weight % | (mils) | Thickness (%) |
| Layer 1 | Interior Skin layer: | 95.0% PETG-1, 3.0 PET-EA, | 16.6 | 0.25 | 13.9 |
| | | 2.0% CPE | | | |
| Layer 2 | Tie Layer: | 90% EVA, 10% COC | 9.1 | 0.185 | 10.3 |
| Layer 3 | Core Layer: | 80% SBC, 20% PS 1 | 48.6 | 0.930 | 51.7 |
| Layer 4 | Tie Layer | 90% EVA, 10% COC | 9.1 | 0.185 | 10.3 |
| Layer 5 | Outer Skin Layer: | 95.0% PETG-1, 3.0 PET-EA, | 16.6 | 0.25 | 13.9 |
| | | 2.0% CPE | | | |

Comparative Film 2

Comparative Film 2 was the same as the Control Film 1 with the exception that the skin layers comprised 88 wt. % of PETG-1 and 4 wt % of a MB-1, which includes 3 wt. % EBA by weight of MB-1. The base layer comprised a blend of 80 wt. % SBC and 20 wt. % PS 2. The tie layer comprised a blend of 50 wt. % EMA-1 and 50 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 96.0% PETG-1, 4.0% MB-1 | 16.8 | 0.25 | 13.9 |
| Layer 2 | Tie Layer: | 50% EMA-1, 50% SEPS | 8.8 | 0.185 | 10.3 |
| Layer 3 | Core Layer: | 80% SBC, 20% PS 2 | 49 | 0.930 | 51.7 |
| Layer 4 | Tie Layer | 50% EMA-1, 50% SEPS | 8.8 | 0.185 | 10.3 |
| Layer 5 | Outer Skin Layer: | 96.0% PETG-1, 4.0% MB-1 | 16.8 | 0.25 | 13.9 |

Inventive Film 2

Inventive Film 23 was the same as the Control Film 1 with the exception that the skin layers comprised 88 wt. % of PETG-1 and 12 wt % of a MB-1, which includes 3 wt. % EBA by weight of MB 1. The base layer comprised a blend of 80 wt. % SBC and 20 wt. % PS 2. The tie layer comprised a blend of 50 wt. % EMA and 50 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 88.0% PETG-1, 12.0% MB-1 | 16.8 | 0.25 | 13.9 |
| Layer 2 | Tie Layer: | 50% EMA-1, 50% SEPS | 8.8 | 0.185 | 10.3 |
| Layer 3 | Core Layer: | 80% SBC, 20% PS 2 | 49 | 0.930 | 51.7 |
| Layer 4 | Tie Layer | 50% EMA-1, 50% SEPS | 8.8 | 0.185 | 10.3 |
| Layer 5 | Outer Skin Layer: | 88.0% PETG-1, 12.0% MB-1 | 16.8 | 0.25 | 13.9 |

Inventive Film 3

Inventive Film 3 was the same as the Control Film 1 with the exception that the skin layers comprised a blend of 88 wt. % of PETG-1 and 6 wt % of a MB-1 and 6 wt. % MB-2, which includes 3 wt. % EBA by weight of MB-1, and 2.5 wt. % EBA by weight of MB-2, respectively. The base layer comprised a blend of 80 wt. % SBC and 20 wt. % PS 2. The tie layer comprised a blend of 50 wt. % EMA and 50 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 88.0% PETG-1, 6% MB-1, | 16.8 | 0.25 | 13.9 |
| | | 6% MB-2 | | | |
| Layer 2 | Tie Layer: | 50% EMA-1, 50% SEPS | 8.8 | 0.185 | 10.3 |
| Layer 3 | Core Layer: | 80% SBC, 20% PS 2 | 49 | 0.930 | 51.7 |
| Layer 4 | Tie Layer | 50% EMA-1, 50% SEPS | 8.8 | 0.185 | 10.3 |
| Layer 5 | Outer Skin Layer: | 88.0% PETG-1, 6% MB-1, | 16.8 | 0.25 | 13.9 |
| | | 6% MB-2 | | | |

Comparative Film 3

Comparative Film 3 was the same as the Control Film 1 with the exception that the skin layers comprised a blend of 88 wt. % of PETG-1 and 12 wt % of a MB-3. The base layer comprised a blend of 80 wt. % SBC and 20 wt. % PS 2. The tie layer comprised a blend of 70 wt. % EMA-1 and 30 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 96.0% PETG-1, 4.0% MB-2 | 16.7 | 0.25 | 13.9 |
| Layer 2 | Tie Layer: | 70% EMA-1, 30% SEPS | 8.8 | 0.185 | 10.3 |
| Layer 3 | Core Layer: | 80% SBC, 20% PS 2 | 48.9 | 0.930 | 51.7 |
| Layer 4 | Tie Layer | 70% EMA-1, 30% SEPS | 8.8 | 0.185 | 10.3 |
| Layer 5 | Outer Skin Layer: | 96.0% PETG-1, 4.0% MB-2 | 16.7 | 0.25 | 13.9 |

Inventive Film 3

Inventive Film 3 was the same as the Control Film 1 with the exception that the skin layers comprised a blend of 88 wt. % of PETG-1 and 12 wt % of a MB-3. The base layer comprised a blend of 80 wt. % SBC and 20 wt. % PS 2. The tie layer comprised a blend of 70 wt. % EMA-1 and 30 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 88.0% PETG-1, 12.0% MB-2 | 16.7 | 0.25 | 13.9 |
| Layer 2 | Tie Layer: | 70% EMA-1, 30% SEPS | 8.8 | 0.185 | 10.3 |
| Layer 3 | Core Layer: | 80% SBC, 20% PS 2 | 48.9 | 0.930 | 51.7 |
| Layer 4 | Tie Layer | 70% EMA-1, 30% SEPS | 8.8 | 0.185 | 10.3 |
| Layer 5 | Outer Skin Layer: | 88.0% PETG-1, 12.0% MB-2 | 16.7 | 0.25 | 13.9 |

Inventive Film 4

Inventive Film 4 was the same as the Control Film 1 with the exception that the skin layers comprised a blend of 88 wt. % of PETG-1 and 12 wt % of a MB-3. The base layer comprised a blend of 80 wt. % SBC and 20 wt. % PS 2. The tie layer comprised a blend of 70 wt. % EMA-1 and 30 wt. % SEPS.

| Layer | | | | Thickness | |
|---|---|---|---|---|---|
| No. | Function/Position | Layer Composition | Weight % | (mils) | Thickness (%) |
| Layer 1 | Interior Skin layer: | 88.0% PETG-1, 12.0% MB-3 | 16.7 | 0.25 | 13.9 |
| Layer 2 | Tie Layer: | 70% EMA-1, 30% SEPS | 8.8 | 0.185 | 10.3 |
| Layer 3 | Core Layer: | 80% SBC, 20% PS 2 | 48.9 | 0.930 | 51.7 |
| Layer 4 | Tie Layer | 70% EMA-1, 30% SEPS | 8.8 | 0.185 | 10.3 |
| Layer 5 | Outer Skin Layer: | 88.0% PETG, 12.0% MB-3 | 16.7 | 0.25 | 13.9 |

Table 1 below summarizes the concentration of ethylene bistearamide (EBA), euracamide wax (EA) and antiblock (AB) in the exterior skin layers of the above-described films. Concentrations are given in ppm based on the total ppm of the skin layer.

TABLE 1
Component Concentration in Skin Layers of Films

| | EBA concen- | EA Wax concen- | AB concen- |
|---|---|---|---|
| | tration in | tration in | tration in |
| Film | Skin layer | Skin Layer | skin layer |
| Identification | (ppm) | (ppm) | (ppm) |
| Control Film 1 | 0 | 0 | 3,500 |
| Comparative Film 1 | 0 | 7,200 | 2,000 |
| Comparative Film 2 | 1,200 | 0 | 1,400 |
| Inventive Film 1 | 3,600 | 0 | 4,200 |
| Inventive Film 2 | 3,900 | 300 | 3,600 |
| Comparative Film 3 | 1,400 | 200 | 1,000 |
| Inventive Film 3 | 4,200 | 600 | 3,000 |
| Inventive Film 4 | 4,200 | 0 | 4,800 |

Concurrent Transverse Orientation of Two Overlying Films

In the following Examples, the ability of two samples of the inventive films to be concurrently oriented was evaluated and compared to the Control Films and Comparative Films 1, 2, and 3. A TM Long Bi-axial Film Stretcher unit manufactured by T.M. Long Company of Sommerville, N.J. was used to perform the lab scale orientation process for purposes of evaluating the films. The TM Long Bi-axial Film Stretcher unit had a DOS operating system and included modifications to permit cooling of the film. 60×60 mm square samples of each film were prepared using a die cutter. Two samples of each tested film were then placed in the unit in face-to face contact so that one of the samples was directly overlying the other sample. The two film samples were grasped by a series of clips on all sides. The now secured film samples were preheated with a settable air temperature and allowed to dwell for a specified amount of time prior to stretching. The films were stretched in the transverse direction of the film. (i.e., in the direction that is transverse to the direction of the film exiting the extrusion die (cross direction of the film). Following orientation, the lid on the Stretcher Unit was opened to quench the film.

Following stretching, the film samples were evaluated for welding to each other, tearing, or other defects that may have occurred during stretching. The process conditions and results/observations are described in Table 2 below.

TABLE 2
Concurrent Orientation of Film Samples containing no EBA

| | | Oven | | | EBA | |
|---|---|---|---|---|---|---|
| | Stretching | Orientation | Dwell | Quench | Concentration | |
| Film | TD/MD | Temperature | Time | Temperature | in Skin layer | |
| Identification | Ratio | (° C.) | (sec.) | (° C.) | (ppm) | Results/Observations |
| Control Film 1 | 6.0 × 1.05 | 87.8 | 60 | 36 | 0 | Film samples welded to |
| | | | | | | each other during |
| | | | | | | stretching |
| Control Film 1 | 6.0 × 1.05 | 87.8 | 60 | 36 | 0 | Film samples welded to |
| | | | | | | each other during |
| | | | | | | stretching |
| Control Film 1 | 6.0 × 1.05 | 93 | 60 | 36 | 0 | Film samples welded to |
| | | | | | | each other during |
| | | | | | | stretching |
| Control Film 1 | 6.0 × 1.05 | 99 | 60 | 36 | 0 | Film samples welded to |
| | | | | | | each other during |
| | | | | | | stretching |
| Comparative | 6.0 × 1.05 | 77.8 | 60 | 36 | 0 | Film samples welded to |
| Film 1 | | | | | | each other during |
| | | | | | | stretching |
| Comparative | 6.0 × 1.05 | 79.4 | 60 | 36 | 0 | Film samples welded to |
| Film 1 | | | | | | each other during |
| | | | | | | stretching |
| Comparative | 6.0 × 1.05 | 87.8 | 60 | 36 | 0 | Film samples welded to |
| Film 1 | | | | | | each other during |
| | | | | | | stretching and delaminated |
| | | | | | | when separated |
| Comparative | 6.0 × 1.05 | 90.6 | 60 | 36 | 0 | Film samples welded to |
| Film 1 | | | | | | each other during |
| | | | | | | stretching and delaminated |
| | | | | | | when separated |
| Comparative | 6.0 × 1.05 | 93.3 | 60 | 36 | 0 | Film samples welded to |
| Film 1 | | | | | | each other during |
| | | | | | | stretching and delaminated |
| | | | | | | when separated |
| Comparative | 6.0 × 1.05 | 104.4 | 60 | 36 | 0 | Film samples welded to |
| Film 1 | | | | | | each other during |
| | | | | | | stretching |
| Comparative | 6.0 × 1.05 | | 60 | 36 | 0 | Film samples welded to |
| Film 1 | | | | | | each other during |
| | | | | | | orientation |

TABLE 3
Concurrent Orientation of Films samples containing varying concentrations of EBA

| | | | Oven | | | EBA | |
|---|---|---|---|---|---|---|---|
| | | Stretching | Orientation | Dwell | Quench | Concentration | |
| Sample | Film | TD/MD | Temperature | Time | Temperature | in Skin layers | |
| No. | Identification | Ratio | (° C.) | (sec.) | (° C.) | (ppm) | Results/Observations |
| 1 | Comparative | 6.0 × 1.05 | 77.8 | 60 | 36 | 1,200 | Film samples welded |
| | Film 2 | | | | | | to each other during |
| | | | | | | | stretching |
| 2 | Comparative | 6.0 × 1.05 | 77.8 | 60 | 36 | 1,200 | Film samples welded |
| | Film 2 | | | | | | to each other during |
| | | | | | | | stretching |
| 3 | Comparative | 5.0 × 1.05 | 75 | 60 | 36 | 1,200 | Film samples welded |
| | Film 2 | | | | | | to each other during |
| | | | | | | | stretching |
| 4 | Comparative | 5.0 × 1.05 | 70 | 60 | 36 | 1,200 | Film samples welded |
| | Film 2 | | | | | | to each other during |
| | | | | | | | stretching |
| 5 | Inventive | 6.0 × 1.05 | 77.2 | 60 | 36 | 3,600 | One small area of |
| | Film 2 | | | | | | welding*** |
| 6 | Inventive | 6.0 × 1.05 | 78.3 | 60 | 36 | 3,600 | One small area of |
| | Film 2 | | | | | | welding*** |
| 7 | Inventive | 6.0 × 1.05 | 78.3 | 60 | 36 | 3,600 | No welding |
| | Film 1 | | | | | | |
| 8 | Inventive | 6.0 × 1.05 | 80.0 | 60 | 36 | 3,600 | No welding |
| | Film 1 | | | | | | |
| 9 | Inventive | 6.0 × 1.05 | 84.4 | 60 | 36 | 3,600 | No welding |
| | Film 1 | | | | | | |
| 10-14* | Inventive | 4.0 × | 73.3-77.2 | 60 | 36 | 3,900 | Very slight |
| | Film 2 | 1.02-6.0 × | | | | | welding*** |
| | | 1.05 | | | | | |
| 15 | Inventive | 4.0 × 1.02 | 76.7 | 60 | 36 | 3,900 | No welding |
| | Film 2 | | | | | | |
| 16 | Inventive | 6.0 × 1.05 | 65 | 60 | 36 | 3,900 | No welding |
| | Film 2 | | | | | | |
| 17 | Inventive | 6.0 × 1.05 | 76.1 | 60 | 36 | 3,900 | No welding |
| | Film 2 | | | | | | |
| 18-24 | Comparative | 5.0 × 1.05 | 65-78.3* | 60 | 36 | 1,400 | All films welded |
| | Film 3 | | | | | | |
| 25 | Inventive | 5.0 × 1.05 | 76.7 | 60 | 36 | 3,000 | No welding |
| | Film 3 | | | | | | |
| 26 | Inventive | 5.0 × 1.05 | 78.3 | 60 | 36 | 3,000 | Slight welding*** |
| | Film 3 | | | | | | |
| 27 | Inventive | 5.0 × 1.05 | 77.8 | 60 | 36 | 3,000 | No welding |
| | Film 3 | | | | | | |
| 28 | Inventive | 5.0 × 1.05 | 77.8 | 60 | 36 | 3,000 | Slight welding*** |
| | Film 3 | | | | | | |
| 29 | Inventive | 5.0 × 1.05 | 78.3 | 60 | 36 | 3,000 | No welding |
| | Film 3 | | | | | | |
| 30 | Inventive | 5.0 × 1.05 | 79.4 | 60 | 36 | 3,000 | No welding |
| | Film 3 | | | | | | |

*Five trial runs at oven temperatures between 73.7 and 77.2;
**Seven trials run at oven temperatures between 65 and 78.3° C.
***Samples 5, 6, 10-14, 26, and 28 exhibited slight welding during orientation. It is believed that this slight welding may have been a result of process variations with the TM Long Bi-axial Film Stretcher unit, as these samples were processed on the same day. Subsequent samples of the same film tested on later days were able to be consistently processed without welding.

From Table 1 above, it can be seen that samples oriented with Control Film 1, which did not include any EBA in the skin layers, had severe welding of the films during orientation. Samples prepared with Comparative Film 1, which included euracamide wax, but did not include a N,N′-bis(fatty) amide (e.g., EBA) in the skin layers, also experienced severe welding during orientation. In contrast, the results summarized in Table 2 show that film samples having 3,000 ppm or more EBA in the skin layers were able to be concurrently oriented without welding to each other, which is both surprising and unexpected since samples made from Comparative Film 1, which included a relatively high level of euracamide wax in the skin, welded severely during concurrent orientation.

Comparative Samples 2 and 3 also show that the amount of EBA in the skin layer is an important factor to prevent welding of the films during concurrent orientation. In particular, EBA concentrations of 1,200 and 1,400 ppm in the skin layers of each film did not prevent welding during concurrent orientation. In contrast, samples prepared from Inventive Films 1, 2, and 3 having 3,600, 3,900, and 3,000 ppm of EBA in the skin layers, respectively, were able to be concurrently oriented without, or in some cases, with minimal welding, of the films to each other. Accordingly, it can be seen that the present invention surprisingly provides a method for the concurrent orientation of two films having skin layers comprising a modified polyester.

Machine Direction Orientation

In the following Example, the ability of a film having a skin layer comprising a modified polyester and a N,N′-bis(fatty) amide to be machine direction oriented was evaluated. In particular, Inventive Film 4 was compared to Control Film 1. The films were oriented in the machine directed by running the films over a series of steel rollers similar to the system shown in FIG. 4. The series of rollers included 4 preheat rollers that were used to heat the film to an orientation temperature of 85° C. Following heating, each film sample was passed over a slow draw roller having an “S” wrap between it and a fast draw roller where the films were subjected to stretching in the machine direction. The slow draw and fast draw rollers were maintained at a temperature between 85 to 95° C. The slow draw roller and the preceding preheat roller each had a matte finish. Following stretching, each film sample passed over a series of 6 annealing rollers (87 to 88° C.) and then a chill roller (31 to 32° C.). The film samples were stretched at a 4.0 draw ratio.

Film samples prepared from Control Film 1 exhibited significant sticking to the rollers, which required removal with a brass putty knife and a brass Chore Boy scrubber. In contrast, film samples prepared with inventive Film 4, which included EBA in the skin layer, were able to be machine direction oriented without adhering or sticking to the rollers. Accordingly, this Example shows that embodiments of the present invention also provide methods for machine direction orientation of films having skin layers comprising a modified polyester.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of concurrently orienting two films comprising positioning a first film comprising a skin layer comprising a modified polyester and a N,N′-bis(fatty) amide and a second film comprising a modified polyester and a N,N′-bis(fatty) amide so that the skin layer of the first film contacts the skin layer of the second film;
heating the first and second films to an orientation temperature;
stretching the first and second films in at least one direction while at the orientation temperature, and while the skin layers of the first and second films are contacting each other.

2. The method of claim 1, wherein the first and second films are heated to a temperature that is from 80° C. to 100° C.

3. The method of claim 1, wherein the first and second films are heated to an orientation temperature that is from 85° C. to 95° C.

4. The method of claim 1, wherein the first and second films are separate films.

5. The method of claim 1, wherein the first and second films comprise a film have a tubular configuration.

6. The method of claim 1, wherein the N,N′-bis(fatty) amide comprises N,N′-ethylene bis(stearamide), N,N′-methylene bis(stearamide), N,N′-propylene bis(stearamide), N,N′-ethylene bis(oleamide), N,N′-methylene bis(oleamide), or N,N′-propylene bis(oleamide), and combinations thereof.

7. The method of claim 1, wherein the N,N′-bis(fatty) amide comprises N,N′-ethylene bis(oleamide) and N,N′-ethylene bis(stearamide), and combinations thereof.

8. The method of claim 1, wherein the amount of N,N′-bis(fatty) amide in each of the skin layers is from 2,200 ppm to 6,000 ppm, based on the total ppm of each respective skin layer.

9. The method of claim 1, wherein the amount of N,N′-bis(fatty) amide in each of the skin layers is from 3,000 to 4,400 ppm, based on the total ppm of each respective skin layer.

11. The method of claim 1, wherein the step of stretching the first and second films comprises stretching the first and second films in a transverse direction.

12. The method of claim 1, wherein the step of stretching the first and second films comprises stretching the first and second films in a machine direction.

13. The method of claim 1, wherein the step of stretching the first and second films comprises biaxially stretching the first and second films in a machine direction and a transverse direction.

14. The method of claim 1, wherein the step of stretching the first and second films comprises stretching the first and second films in a single direction.

15. The method of claim 1, wherein the step of stretching comprises stretching the first and second films using a tenter frame.

16. The method of claim 1, wherein the first and second films are heated to a temperature that is no higher than 30° C. above the glass transition temperature of the modified polyester of the skin layers of the first and second films.

17. A method of orienting a film in the machine direction comprising:
providing a film having an outer layer comprising modified polyester and N,N′-bis(fatty) amide;
heating the film to an orientation temperature;
passing the film over roller to orient the heated film while at the orientation temperature of the film;
stretching the heated film in the machine direction while at the orientation temperature.

18. The method of claim 17, wherein the film is heated to a temperature that is from 80° C. to 100° C.

19. The method of claim 17, wherein the film is heated to a temperature that is no higher than 30° C. above the glass transition temperature of the modified polyester of the outer layer.

20. The method of claim 17, wherein the N,N′-bis(fatty) amide comprises N,N′-ethylene bis(stearamide), N,N′-methylene bis(stearamide), N,N′-propylene bis(stearamide), N,N′-ethylene bis(oleamide), N,N′-methylene bis(oleamide), or N,N′-propylene bis(oleamide), and combinations thereof.

21. The method of claim 17, wherein the N,N′-bis(fatty) amide comprises N,N′-ethylene bis(oleamide) and N,N′-ethylene bis(stearamide), and combinations thereof.

22. The method of claim 17, wherein the modified polyester comprises glycol-modified polyester.

23. The method of claim 17, wherein the amount of N,N′-bis(fatty) amide in outer layer is at least 3,000 ppm, based on the total ppm of the outer layer.

24. The method of claim 17, wherein the step of heating the film comprises passing the film over a series of heated rollers.
